(19) United States
(12) Patent Application Publication
(10) Pub. No.: US 2015/0020102 A1
(43) Pub. Date: Jan. 15, 2015

(54) MULTI-CHANNEL GUIDE SERVICE BASED ON BROADCAST RATING

(71) Applicant: KT CORPORATION, Gyeonggi-do (KR)

(72) Inventors: Young-Il YOO, Gyeonggi-do (KR); Dong-Hoon KIM, Gyeonggi-do (KR); I-Gil KIM, Gyeonggi-do (KR); Gyu-Tae BAEK, Seoul (KR)

(73) Assignee: KT CORPORATION

(21) Appl. No.: 14/332,308

(22) Filed: Jul. 15, 2014

(30) Foreign Application Priority Data
Jul. 15, 2013 (KR) 10-2013-0083074

(51) Int. Cl. H04N 21/482; H04N 21/854

(52) U.S. Cl. CPC H04N 21/4826; H04N 21/854
USPC 725/41

(57) ABSTRACT

The disclosure is related to providing a dynamic multi-channel guide service based on broadcast ratings. Particularly, a multi-channel guide stream corresponding to a single combined video stream may be formed using a plurality of encoded video data extracted from a plurality of broadcast channel streams, according to multi-channel guide configuration information. Herein, the multi-channel guide configuration information may be determined based on the broadcast ratings.

### CROSS REFERENCE TO PRIOR APPLICATIONS

The present application claims priority under 35 U.S.C. §119 to Korean Patent Application No. 10-2013-0083074 (filed on Jul. 15, 2013), which is hereby incorporated herein by reference in its entirety.

The subject matter of this application is related to U.S. patent application Ser. No. ______ (filed on xx, xx, 2014), as Attorney Docket No. 801.0146 and U.S. patent application Ser. No. ______ (filed on xx, xx, 2014), as Attorney Docket No. 801.0144, the teachings of which are incorporated herein their entirety by reference.

### TECHNICAL FIELD

The present disclosure relates to a broadcast service and, in particular, to providing a multi-channel guide service based on broadcast ratings.

### BACKGROUND

Lately, TV devices using a picture-in-picture (PIP) technique has been introduced. The PIP technique enables the TV devices to display a plurality of broadcast channels on a single screen. In order to perform such PIP operation, a TV device receives a plurality of broadcast signals, decodes each of the received broadcast signals through a plurality of decoders corresponding to the number of the received broadcast signals, and displays the decoded broadcast signals on a single screen by using PIP technique. In other words, in order to display a plurality of broadcast channels on a single screen, the TV device may be required to include a plurality of decoders.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, a multi-channel guide stream (e.g., a mosaic-type multi-channel guide stream) may be created by performing a video stream combination such that a plurality of broadcast video streams are displayed on a multi-channel guide screen. More specifically, in case of performing the video stream combination according to the present embodiment, a multi-channel guide stream corresponding to a single combined video stream may be created using a plurality of ‘encoded video data’ (i.e., video bitstream) extracted from a plurality of broadcast video streams, without decoding each of the plurality of video streams. Furthermore, such multi-channel guide stream may be dynamically created based on broadcast ratings (e.g., real-time broadcast ratings). Accordingly, the deployment of each broadcast channel display area on a multi-channel guide screen may be changed according to the broadcast ratings.

In accordance with at least one embodiment, a method may be provided for a multi-channel guide service. The method may include obtaining broadcast ratings; obtaining a plurality of broadcast channel streams associated with the broadcast ratings; creating a multi-channel guide stream using encoded video data included in each of the plurality of broadcast channel streams, according to multi-channel guide configuration information, wherein the multi-channel guide configuration information is determined based on the broadcast ratings; and providing the multi-channel guide stream to at least one of a broadcast server and user equipment.

The obtaining broadcast ratings may include receiving periodically the broadcast ratings from a statistical information providing server.

The plurality of broadcast channel streams may be broadcast channel streams in a predetermined ranking range.

The creating a multi-channel guide stream may include extracting encoded video data in a unit of video frame, from each of the plurality of broadcast channel streams; creating a plurality of slice group data to be used for creation of the multi-channel guide stream, from a plurality of encoded video data; creating slice group header information per slice group data; and forming the multi-channel guide stream including the plurality of slice group data and a plurality of slice group header information.

The creating a plurality of slice group data may include at least one of (i) adjusting a data size of each encoded video data; and (ii) adding guard area data to each encoded video data.

The adjusting may include performing a data size adjustment such that each encoded video data is displayed at a predetermined screen area on a target display screen.

The data size adjustment may be performed according to a mapping relation of each broadcast channel stream and a slice group corresponding to the target screen area. The mapping relation may be determined based on the broadcast ratings.

The adding guard area data may include adding the guard area data to each size-adjusted encoded video data such that a decoding error due to neighboring slice groups is prevented.

The slice group header information may include position information associated with each slice group corresponding to each slice group data. The position information may be determined based on the broadcast ratings.

The position information may be determined such that each encoded video data is displayed at a predetermined screen area on a target display screen.

The method may further include creating a broadcast channel guide transport stream (TS) by multiplexing at least one of the multi-channel guide stream, corresponding audio streams, and additional information.

The additional information may include at least one of (i) metadata associated with configuration of the multi-channel guide stream, and (ii) access information of the broadcast server.

The method may further include performing a frame type synchronization for the plurality of slice group data.

The slice group data and the slice header information may be based on a flexible macroblock ordering (FMO) technique.

The multi-channel guide configuration information may be associated with a preset user interface (UI) template.

In accordance with other embodiments, a system may provide a multi-channel guide service. The system may include a first receiver, a second receiver, a multi-channel guide creation processor, and a transmitter. Herein, the first receiver may be configured to obtain broadcast rating. The second receiver may be configured to receive a plurality of broadcast channel streams associated with the broadcast ratings. The multi-channel guide creation processor may be configured to create a multi-channel guide stream using encoded video data included in each of the plurality of broadcast channel streams, according to multi-channel guide configuration information. Herein, the multi-channel guide configuration information may be determined based on the broadcast ratings. The transmitter may be configured to transmit the multi-channel guide stream to at least one of a broadcast server and user equipment.

The plurality of broadcast channel streams may be broadcast channel streams in a predetermined ranking range.

The multi-channel guide creation processor may be configured (i) to extract encoded video data in a unit of video frame, from each of the plurality of broadcast channel streams; (ii) to create a plurality of slice group data to be used for creation of the multi-channel guide stream, from a plurality of encoded video data; (iii) to create slice group header information per slice group data; and (iv) to form the multi-channel guide stream including the plurality of slice group data and a plurality of slice group header information.

The multi-channel guide creation processor may be configured to create the plurality of slice group data by performing at least one of (i) a data size adjustment procedure for each encoded video data such that each encoded video data is displayed at a predetermined screen area on a target display screen; and (ii) a guard area adding procedure for preventing a decoding error due to neighboring slice groups.

The slice group header information may include position information associated with each slice group corresponding to each slice group data. The position information may be determined based on the broadcast ratings.

### BRIEF DESCRIPTION OF THE DRAWINGS

The above and/or other aspects of some embodiments of the present invention will become apparent and more readily appreciated from the following description of embodiments, taken in conjunction with the accompanying drawings, of which:

FIG. 1 illustrates interworking between systems for providing a multi-channel guide service using a video stream combination in accordance with at least one embodiment;

FIG. 2 is a block diagram illustrating a structure of a multi-channel guide providing server in accordance with at least one embodiment;

FIG. 3 is a block diagram illustrating another structure of a multi-channel guide providing server in accordance with other embodiments;

FIG. 4 illustrates a method of providing a multi-channel guide service using a video stream combination in accordance with at least one embodiment;

FIG. 5 illustrates a method of creating a multi-channel guide stream using a video stream combination in accordance with at least one embodiment;

FIG. 6 illustrates an exemplary user interface for a mosaic-type multi-channel guide screen in accordance with at least one embodiment;

FIG. 7A and FIG. 7B illustrate a mapping relation between broadcast channel video streams and slice groups in accordance with at least one embodiment;

FIG. 8A and FIG. 8B illustrate a concept of a video stream combination which is performed in a unit of frame in accordance with at least one embodiment;

FIG. 9 illustrates a bitstream structure of a multi-channel guide stream corresponding to a single combined video stream in accordance with at least one embodiment; and

FIG. 10A and FIG. 10B illustrate a method of adding a guard area in order to overcome a decoding error at a boundary portion of slice groups in accordance with at least one embodiment.

### DETAILED DESCRIPTION OF EMBODIMENTS

Reference will now be made in detail to exemplary embodiments of the present invention, examples of which are illustrated in the accompanying drawings, wherein like reference numerals refer to like elements throughout. The embodiments are described below, in order to explain embodiments of the present invention by referring to the figures.

The present embodiment may provide a multi-channel guide service using a video stream combination. A multi-channel guide stream (e.g., a mosaic-type multi-channel guide stream) according to the present embodiment may be formed by performing a video stream combination such that a plurality of broadcast video streams are displayed on a multi-channel guide screen. More specifically, in case of performing the video stream combination according to the present embodiment, a multi-channel guide stream corresponding to a single combined video stream may be created using a plurality of ‘encoded video data’ (i.e., video bitstream) extracted from a plurality of broadcast video streams, without decoding each of the plurality of video streams. Furthermore, such multi-channel guide stream may be dynamically created according to broadcast ratings (e.g., real-time broadcast ratings). Accordingly, the deployment of each broadcast channel display area on a multi-channel guide screen may be changed according to the broadcast ratings.

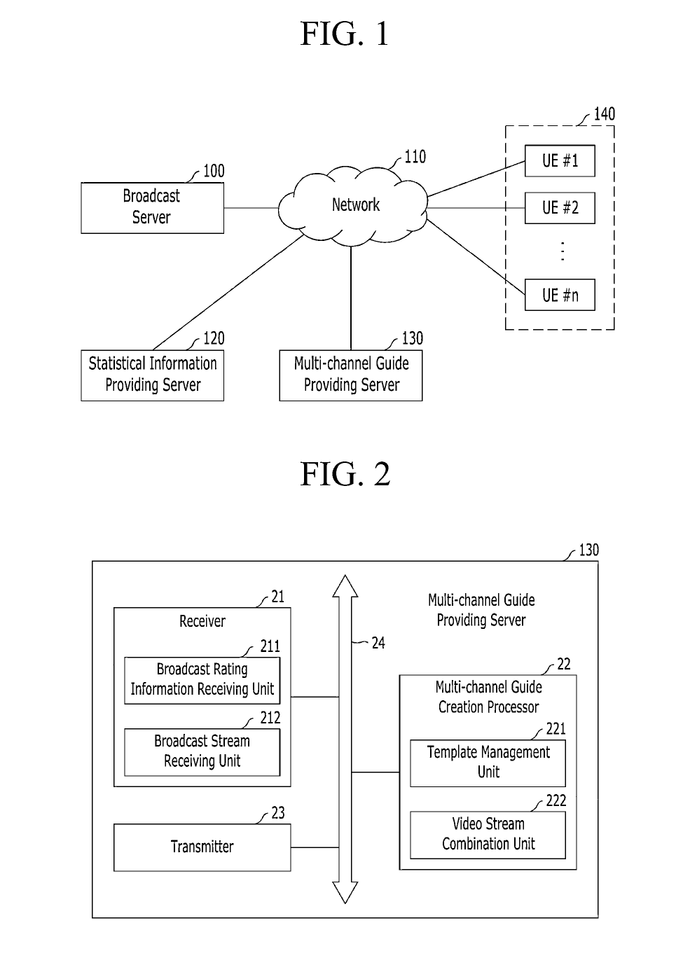

FIG. 1 illustrates interworking between systems for providing a multi-channel guide service using a video stream combination in accordance with at least one embodiment.

Referring to FIG. 1, a multi-channel guide service according to the present embodiment may be provided through interworking between broadcast server 100, statistical information providing server 120, and multi-channel guide providing server 130.

Broadcast server 100 may transmit one or more broadcast channel streams (e.g., a broadcast channel transport streams). Herein, the broadcast channel streams may include a variety of video streams such as a video on demand (VOD) content stream, an Internet broadcast stream, and so forth. Hereinafter, the broadcast channel stream(s) may be simply referred to as “broadcast stream(s).” Broadcast server 100 may transmit one or more broadcast streams to user equipment 140 through a variety of networks (e.g., 110). In at least one embodiment, broadcast server 100 may be each broadcast station which transmits an original broadcast stream. Alternatively, broadcast server 100 may be a media management center which receives a broadcast steam from the broadcast station and re-transmits the received broadcast stream to a local broadcast server and/or user equipment 140. In other embodiments, broadcast server 100 may be a service provider server which provides a broadcast service, or a content provider server which provides such multimedia content service as a VOD service. However, types of broadcast server 100 is not limited thereto.

Broadcast server 100 may represent a broadcast server which transmits a plurality of broadcast channel streams. Alternatively, broadcast server 100 may include a plurality of broadcast servers. In this case, each broadcast server may transmit a corresponding broadcast channel stream.

With respect to a transmission scheme, broadcast server 100 may transmit one or more broadcast channel streams through one of a broadcast transmission scheme, a multicast transmission scheme, and a unicast transmission scheme. Furthermore, broadcast server 100 may multiplex a plurality of broadcast channel streams, and then transmit the multiplexed broadcast channel streams to user equipment 140. Alternatively, broadcast server 100 may independently transmit each broadcast channel stream to user equipment 140.

Furthermore, broadcast server 100 may receive a multi-channel guide stream based on broadcast ratings (i.e., viewer ratings), from multi-channel guide providing server 130. In this case, broadcast server 100 may transmit the received multi-channel guide stream to user equipment 140 through network 110. In at least one embodiment, broadcast server 100 may multiplex at least one broadcast channel stream and the received multi-channel guide stream, and then transmit the multiplexed streams to user equipment 140. Alternatively, broadcast server 100 may independently transmit the received multi-channel guide stream to user equipment 140.

Meanwhile, network 110 may include a variety of networks such as a 3rd generation partnership project (3GPP) network, a long term evolution (LTE) network, a world interoperability for microwave access network (WIMAX), Internet, a wireless local area network (LAN), a wide area network (WAN), a personal area network (PAN), a Bluetooth network, a terrestrial broadcast network, a cable broadcast network, a satellite broadcast network, and/or a cable network, but are not limited thereto.

Statistical information providing server 120 may periodically (or in real time) provide broadcast rating information (i.e., viewer rating information) to multi-channel guide providing server 130. Herein, the broadcast rating information may be associated with a plurality of broadcast channel streams provided by broadcast server 100. The broadcast rating may be a percentage indicating the number of audience members of a specific broadcast program (e.g., a specific broadcast channel stream). The broadcast rating(s) may be referred to as “audience rating(s),” “viewer rating(s),” and “rating(s),” but is not limited thereto.

Statistical information providing server 120 may perform a broadcast rating measurement (or survey). Alternatively, statistical information providing server 120 may collect and store broadcast rating information from corresponding broadcasting companies. In other embodiments, statistical information providing server 120 may be a measurement and statistics subsystem (MSS) in a cloud-based operation center.

Multi-channel guide providing server 130 may periodically receive (or obtain) broadcast rating information from statistical information providing server 120. Herein, the broadcast rating information may be associated with a plurality of broadcast channel streams provided by broadcast server 100. Meanwhile, multi-channel guide providing server 130 may receive (or obtain) only broadcast channel streams associated with the broadcast ratings received by broadcast rating information receiving unit 211. Herein, the received (obtained) broadcast channel streams for creating a multi-channel guide stream may be broadcast channel streams (e.g., broadcast channel streams corresponding to ranking #1 to ranking #9) in a predetermined ranking range.

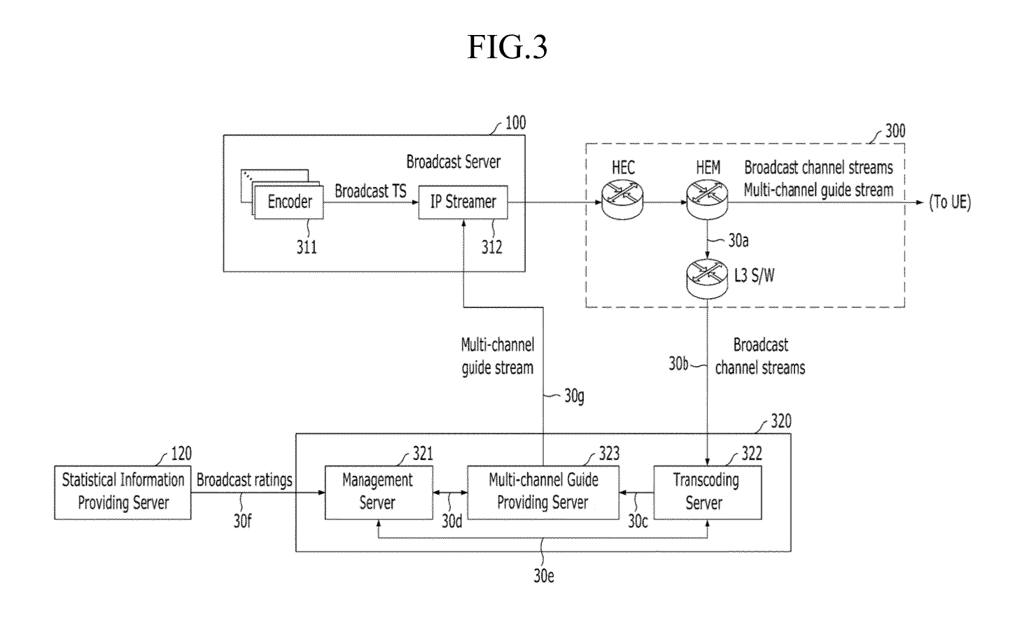

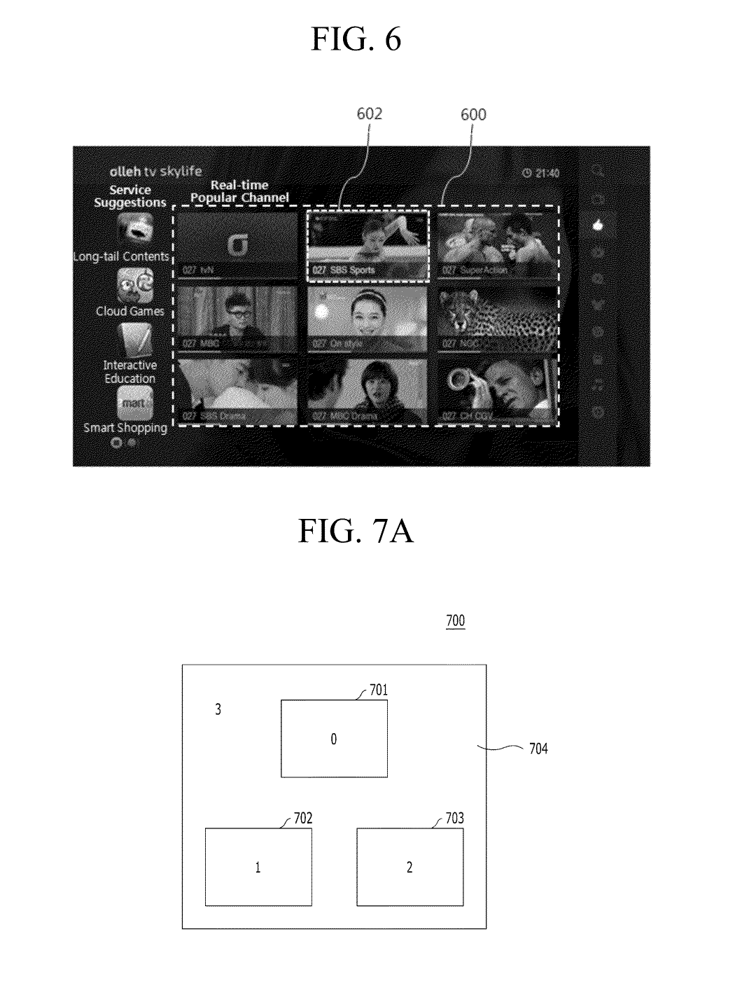

Furthermore, multi-channel guide providing server 130 may create a multi-channel guide stream by combining (or stitching) the received (collected) broadcast channel streams according to multi-channel guide configuration information based on the broadcast ratings. The procedure of creating the multi-channel guide stream will be described in more detail with reference to FIG. 2, and FIG. 5 through FIG. 10B.

When creating a multi-channel guide stream, multi-channel guide providing server 130 may transmit the created multi-channel guide stream to broadcast server 100. In this case, broadcast server 100 may transmit the received multi-channel guide stream to user equipment 140 through network 110. In other embodiments, multi-channel guide creation processor 22 may transmit the multi-channel guide stream to at least one user equipment 140 (e.g., UE #1, . . . , or UE #n).

User equipment 140 (e.g., UE #1, . . . , UE #n) may receive a multi-channel guide stream from broadcast server 100. Alternatively, user equipment 140 (e.g., UE #1, . . . , UE #n) may receive the multi-channel guide stream from multi-channel guide providing server 130. When receiving the multi-channel guide stream, user equipment 140 may display the multi-channel guide stream corresponding to a single combined video stream. In this case, a plurality of encoded video data (e.g., encoded video data corresponding to at least one broadcast channel stream) included in the multi-channel guide stream may be simultaneously displayed on a single screen of user equipment 140. Herein, user equipment 140 may include a device capable of displaying a video stream. For example, user equipment 140 may include a communication terminal having a display screen, a smart phone, a personal computer system, a set-top box connected to a television (TV), a smart TV, and/or an internet protocol (IP) TV, but is not limited thereto.

FIG. 2 is a block diagram illustrating a detailed structure of a multi-channel guide providing server in accordance with at least one embodiment.

Referring to FIG. 2, the multi-channel guide providing server (e.g., 130) according to at least one embodiment may include receiver 21, multi-channel guide creation processor 22, and transmitter 23. Herein, receiver 21, multi-channel guide creation processor 22, and transmitter 23 may be communicatively coupled via bus 24.

Receiver 21 may receive broadcast rating information and/or a plurality of broadcast channel streams. More specifically, receiver 21 may include broadcast rating information receiving unit 211 and broadcast stream receiving unit 212.

Broadcast rating information receiving unit 211 corresponding to a sub-processor may periodically receive (or obtain) broadcast rating information from statistical information providing server 120. Herein, the broadcast rating information may be associated with a plurality of broadcast channel streams provided by broadcast server 100. In at least one embodiment, statistical information providing server 120 may periodically provide broadcast rating information to multi-channel guide providing server 130 (more specifically, broadcast rating information receiving unit 211). Alternatively, statistical information providing server 120 may provide broadcast rating information to broadcast rating information receiving unit 211, in response to a request for the broadcast rating information. Herein, the messages transmitted/received between statistical information providing server 120 and multi-channel guide providing server 130 (more specifically, broadcast rating information receiving unit 211) may be hypertext transfer protocol (HTTP) based messages, but are not limited thereto.

For example, the broadcast ratings may be transmitted from statistical information providing server 120 to broadcast rating information receiving unit 211, in a form of an HTTP message as shown in [Table 1] below.

TABLE 1

| | |
|---|---|
| URL | /OTV/101/1/40/json?sid= RAP0001 |

```
Response
{
    “time”: “201301011300”,
    “ratings”: {
        “1”: {
            “channel”: “7”,
            “rating”: 23.24
        },
        “2”: {
            “channel”: “11”,
            “rating”: 15.0
        },
        “3”: {
            “channel”: “5”,
            “rating”: 9.07
        },
        ... ( 40 Defaults ) ...
        “4”: {
            “channel”: “9”,
            “rating”: 6.28
        }
    }
}
```

Referring to [Table 1], broadcast channel 7 has the highest viewing rate of 23.24 at 1:00 pm on Jan. 1, 2013.

Broadcast stream receiving unit 212 corresponding to a sub-processor may receive (or obtain) a plurality of broadcast channel streams transmitted from broadcast server 100. In particular, in at least one embodiment, broadcast stream receiving unit 212 may receive (or obtain) only broadcast channel streams associated with the broadcast ratings received by broadcast rating information receiving unit 211. Herein, the received (obtained) broadcast channel streams for creating a multi-channel guide stream may be broadcast channel streams (e.g., broadcast channel streams corresponding to ranking #1 to ranking #9) in a predetermined ranking range.

Multi-channel guide creation processor 22 may create a multi-channel guide stream by combining (or stitching) the received (collected) broadcast channel streams according to multi-channel guide configuration information based on the broadcast ratings. More specifically, multi-channel guide creation processor 22 may include template management unit 221 and video stream combination unit 222.

Template management unit 221 corresponding to a sub-processor may create, store, and/or manage a variety of templates (e.g., UI templates) associated with a multi-channel guide screen (e.g., a mosaic channel guide screen). In particular, template management unit 221 may create a variety of templates based on broadcast ratings. More specifically, template management unit 221 may register and manage a plurality of templates which are designed based on a hypertext markup language 5 (HTML 5). In this case, template management unit 221 may create a variety of multi-channel guide screens (e.g., N×N mosaic-type channel guide screen) by modifying a cascading style sheet (CSS) file of HTML 5. For example, templates (e.g., UI templates) associated with a multi-channel guide screen (e.g., a mosaic channel guide screen) may be in a 2×2, 3×3, or 4×4 matrix, but are not limited thereto. In other words, shapes and sizes of the multi-channel guide screen may be configured through a variety of templates. Furthermore, Java Script or cascading style sheet (CCS) may be used to add or change animation effects and/or fonts on a multi-channel guide screen (e.g., a mosaic channel guide screen). In at least embodiment, templates (e.g., UI templates associated with a multi-channel guide screen) created/managed by template management unit 221 may be transmitted as metadata directly or indirectly (i.e., via broadcast server 100) to user equipment 140.

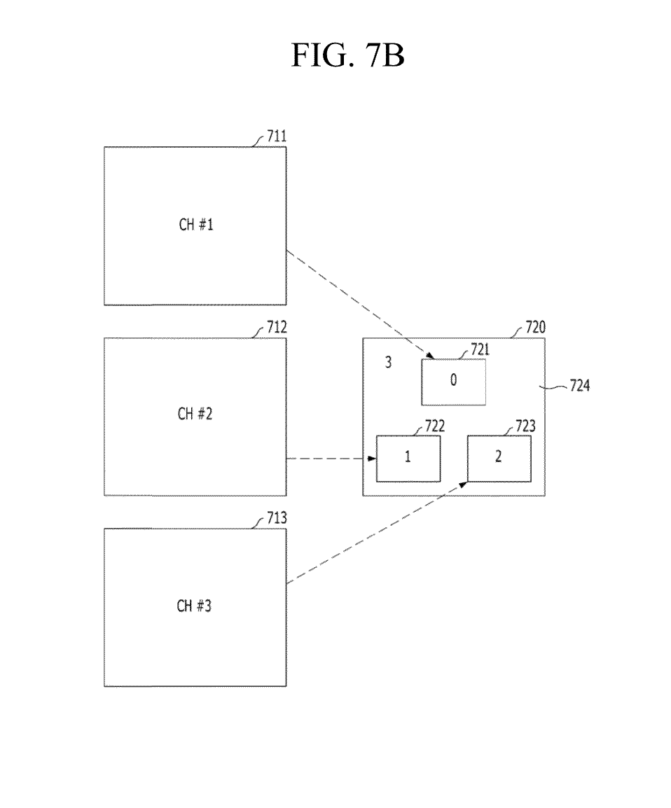

Furthermore, templates (e.g., UI templates) associated with a multi-channel guide screen (e.g., a mosaic channel guide screen) may include screen configuration information (e.g., a display position and/or a size of each broadcast channel stream, for example, “602” in FIG. 6) associated with deployment of broadcast channel streams. Particularly, as described above, the templates associated with a multi-channel guide screen may be configured based on the broadcast ratings and/or a broadcast schedule. The templates may be configured such that additional information associated with each broadcast channel stream overlays on a corresponding stream image (e.g., “602” in FIG. 6) of a multi-channel guide screen. Herein, the additional information associated with each broadcast channel stream may include at least one of a channel number, a channel name, a program schedule, and so forth.

In the case that broadcast ratings is changed and then rankings are changed, template management unit 221 may modify or update corresponding templates (e.g., UI templates) associated with a multi-channel guide screen. In this case, corresponding templates may be modified or updated such that broadcast channel streams with a comparatively higher rating are deployed in a upper row of the multi-channel guide screen.

A multi-channel guide screen may be changed according to broadcast ratings. For this case, template management unit 221 may add an animation effect to a templates associated with a multi-channel guide screen. Accordingly, while a multi-channel guide screen is changed in user equipment, an animation effect may be displayed on user equipment. Herein, the animation effect may include fade in/fade out effects, a rotation effect, a scale change, and/or a sliding effect, but is not limited thereto.

Template management unit 221 may create templates (e.g., UI templates) such that a multi-channel guide screen (e.g., a mosaic channel guide screen) has a plurality of screen pages. Herein, the number of screen pages may be determined the number of broadcast channels to displayed on the multi-channel guide screen. For example, template management unit 221 may create three screen pages of a 3×3 matrix to accommodate 27 different broadcast channels. Herein, each screen page may be in same or different shapes.

In the case that a multi-channel guide screen (e.g., a mosaic-type channel guide screen) is formed by a plurality of screen pages, users may perform a screen page change through a remote controller (e.g., button input) and/or a user touch gesture. Furthermore, template management unit 221 may create metadata associated with a multi-channel guide screen configuration such that a broadcast channel change can be performed on a multi-channel guide screen according to a user selection. Such metadata may be included in a multi-channel guide stream (e.g., a multi-channel guide transport stream). In this case, such metadata may be transmitted to user equipment 140 through broadcast server 100. In other embodiments, transmitter 23 may transmit the metadata to user equipment 140. Accordingly, user equipment 140 may perform a broadcast channel change using the meta data associated with a multi-channel guide screen configuration.

In other embodiments, template management unit 221 may create a multi-channel guide screen (e.g., a mosaic-type channel guide screen) according to genres. For example, a multi-channel guide screen (or a screen page) for sport channels may be formed in a 2×2 matrix. A multi-channel guide screen (or a screen page) for shopping channels may be formed in a 3×3 matrix. A multi-channel guide screen (or a screen page) for sport channels may be formed in a 2×3 matrix. Furthermore, template management unit 221 may create additional data (e.g., a text, an image) to be displayed on a multi-channel guide screen through an overlay scheme. The additional data may be transmitted as metadata to user equipment 140. In this case, user equipment 140 may decode a multi-channel guide stream, and thereafter overlay the additional data on a multi-channel guide screen.

Video stream combination unit 222 corresponding to a sub-processor may create a multi-channel guide stream (e.g., a mosaic-type channel guide stream) by combining (or stitching) the received (collected) broadcast channel streams according to multi-channel guide configuration information. Herein, video stream combination unit 222 may be referred to as “multi-channel guide stream creation unit.” The multi-channel guide configuration information (may be referred to as “multi-channel guide screen configuration information”) may be deployment information of broadcast channel streams. In particular, the multi-channel guide configuration information may be determined based on the broadcast ratings. Furthermore, the multi-channel guide configuration information may be recognized (or obtain) from a preset template associated with a multi-channel guide screen. In other words, video stream combination unit 222 may create a multi-channel guide stream (e.g., a mosaic-type channel guide stream) according to the multi-channel guide configuration information determined through a preset template. In at least one embodiment, video stream combination unit 222 may create a multi-channel guide transport stream (TS) including the multi-channel guide video stream. Herein, the multi-channel guide transport stream (TS) corresponding to a single combined transport stream (TS) may include the multi-channel guide video stream (corresponding to a single combined video stream), a plurality of audio streams, and/or additional data (e.g., metadata such as multi-channel UI templates). The procedure of creating the multi-channel guide stream will be described in more detail with reference to FIG. 5 through FIG. 10B.

Transmitter 23 may transmit the created multi-channel guide stream to broadcast server 100. Furthermore, transmitter 23 may transmit a variety of metadata associated with a multi-channel guide stream to broadcast server 100 and/or user equipment 140. In this case, when receiving a multi-channel guide stream and/or corresponding metadata from multi-channel guide providing server 130 (more specifically, transmitter 23), broadcast server 100 may transmit the multi-channel guide stream and/or the corresponding metadata to user equipment 140 (e.g., UE #1, . . . , or UE #n). Herein, the metadata may include multi-channel guide configuration information. More specifically, the metadata may include (i) UI templates (e.g., N×N screen configuration) and/or template configuration information, (ii) position information (e.g., top-left information or bottom-right information) of each screen tile (e.g., each display area for each broadcast channel stream), (iii) service identification (ID) of each screen tile, (iv) additional information (e.g., a channel number, a channel name, or a program schedule) to be overlaid on a corresponding stream image (e.g., “602” in FIG. 6) of a multi-channel guide screen, (v) position information (e.g., coordinate values) of a selection box to be overlaid on a multi-channel guide screen, and/or (vi) information (e.g., channel numbers, URL) to be used for a channel change according to a tile selection, but is not limited thereto. In at least one embodiment, user equipment 140 may identify broadcast channels through the service ID. In at least one embodiment, transmitter 23 may transmit a multi-channel guide transport stream (TS) created by multiplexing a multi-channel guide video stream, corresponding audio streams, and/or the metadata.

In other embodiments, transmitter 23 may transmit the metadata to at least one user equipment 140 (e.g., UE #1, . . . , or UE #n). Furthermore, transmitter 23 may transmit the multi-channel guide stream to at least one user equipment 140 (e.g., UE #1, . . . , or UE #n).

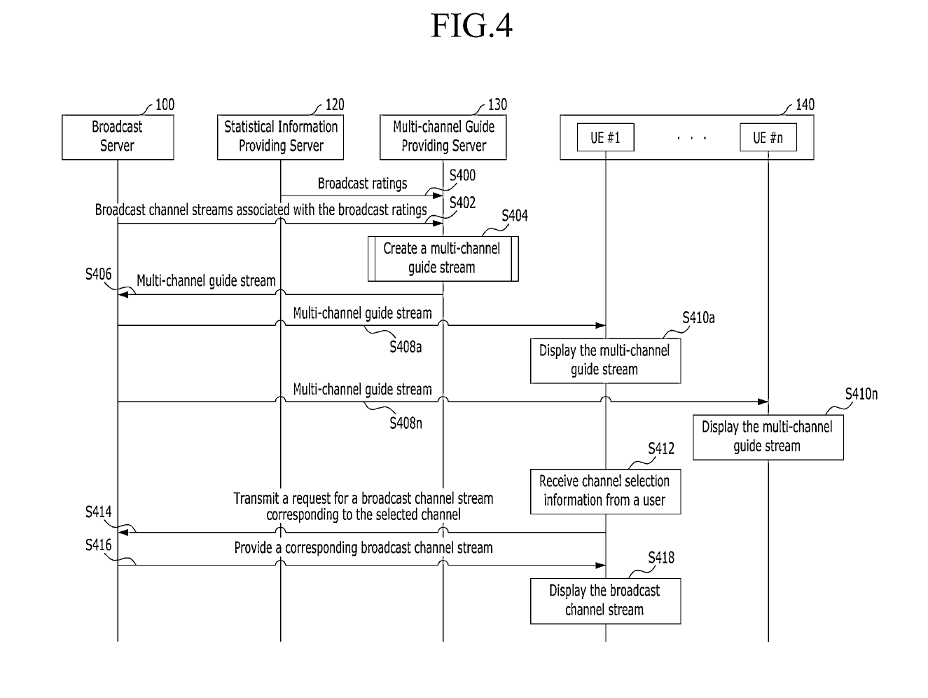

FIG. 3 is a block diagram illustrating another structure of a multi-channel guide providing server in accordance with other embodiments.

Referring to FIG. 3, since the elements (or procedures) of the present embodiment are similar to those of the embodiment described with reference to FIG. 1 and FIG. 2, the following description will focus on differences therebetween for convenience.

As described in FIG. 2, broadcast server 100 may transmit a plurality of broadcast channel streams to user equipment 140. More specifically, broadcast server 100 may include encoder 311 and IP streamer 312. Herein, encoder 311 may create one or more broadcast channel transport streams by encoding one or more broadcast sources. Encoder 311 may correspond to a plurality of encoder. IP streamer 312 may transmit the one or more broadcast channel transport streams through an IP broadcast network (e.g., 300). In this case, IP streamer 312 may individually transmit each broadcast channel transport stream o user equipment 140. Alternatively, IP streamer 312 may multiplex a plurality of broadcast channel transport streams, and then transmit the multiplexed broadcast channel transport stream to user equipment 140. Furthermore, IP streamer 312 may receive a multi-channel guide stream (e.g., multi-channel guide transport stream) from multi-channel guide providing server 323. In this case, IP streamer 312 may transmit the received multi-channel guide stream to user equipment 140. More specifically, IP streamer 312 may individually transmit the received multi-channel guide stream to user equipment 140. Alternatively, IP streamer 312 may multiplex a plurality of broadcast channel transport streams and the received multi-channel guide stream, and then transmit the multiplexed transport stream to user equipment 140.

Statistical information providing server 120 may periodically (or in real time) provide broadcast rating information (i.e., viewer rating information) to a multi-channel guide providing system (e.g., 320) (more specifically, management server 321). Since the basic operation of statistical information providing server 120 was already described with reference to FIG. 1 and FIG. 2, the detailed description thereof is omitted.

Multi-channel guide providing system 320 according to at least embodiment may include management server 321, transcoding server 322, and multi-channel guide providing server 323.

Management server 321 may perform a variety of management functions associated with creation of a multi-channel guide stream (e.g., a mosaic-type channel guide stream). Herein, management server 321 may be referred to as “web application server.” Management server 321 may perform a broadcast channel list management, a broadcast program information management, a broadcast rating information management, a subscriber information management, a service information management, a profile management, a UI template registration/management associated with a multi-channel guide screen, a metadata creation/management associated with a multi-channel guide screen, a metadata encoding, and/or a source access information registration/management, but is not limited thereto. Herein, the source access information may include broadcast channel information, URL information, and so forth.

Particularly, management server 321 may perform a variety of ‘template related functions’ described in connection with template management unit 221 in FIG. 2. In other words, management server 321 may create multi-channel guide configuration information based on the broadcast ratings, and provide the multi-channel guide configuration information to multi-channel guide providing server 323. Furthermore, management server 321 may receive broadcast program information (e.g., EPG) from broadcast server 100, and store and/or manage the received broadcast program information. Management server 321 may receive broadcast rating information from statistical information providing server 120, and store and/or manage the received broadcast rating information. Management server 321 may manage and control operations and states of multi-channel guide providing server 323 and/or transcoding server 322.

In other embodiments, users may access management server 321, receive a variety of user interface (UI) templates associated with a screen configuration of a multi-channel guide stream, and select (or register) at least one UI template. Furthermore, users may change the registered UI template(s) to one or more different/new UI templates. In the case that a specific UI template is selected by a user, a multi-channel guide providing server (e.g., 323) may create a multi-channel guide stream according to screen configuration information corresponding to the selected UI template.

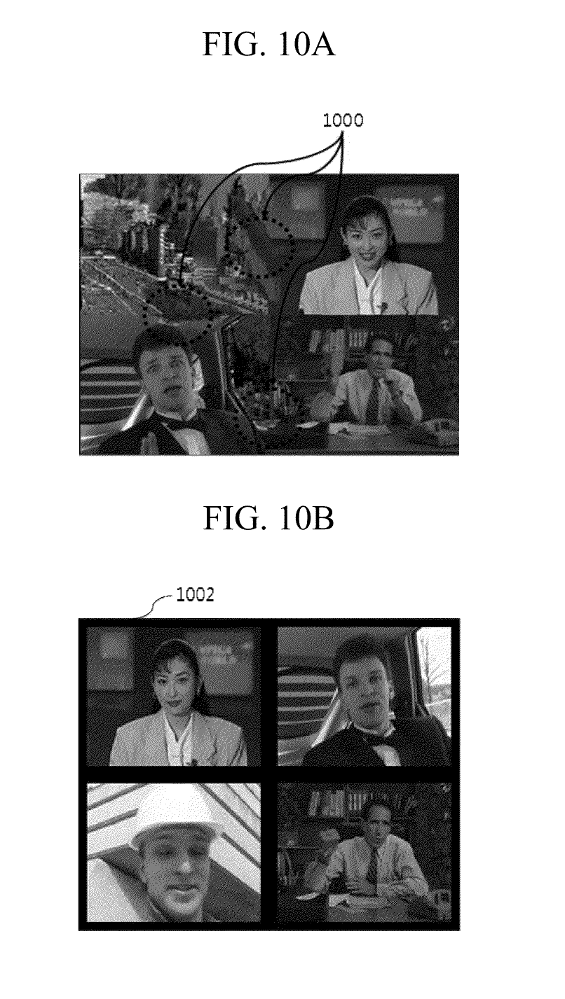

Transcoding server 322 may receive a plurality of broadcast channel streams used for creation of a multi-channel guide stream, and perform in advance a transcoding procedure associated with the plurality of broadcast channel streams. Herein, the transcoding server 322 may receive broadcast channel streams belonging to a predetermined ranking range. More specifically, transcoding server 322 may create size-adjusted broadcast channel stream (e.g., size-adjusted broadcast channel TS) by transcoding the broadcast channel streams (e.g., broadcast channel TSs) received from broadcast server 100. Particularly, transcoding server 322 may perform a size adjustment (e.g., a resolution change) for the received broadcast channel streams (e.g., broadcast channel TSs) such that each broadcast channel stream is displayed at a predetermined screen area on a target display screen (i.e., a multi-channel guide screen). Transcoding server 322 may add guard area data to each size-adjusted video data. Such procedure of adding a guard area will be described in more detail with reference to FIG. 5 (“S508”), FIG. 10A, and FIG. 10B. In order to perform the size adjustment (e.g. down-sizing) and guard area adding, transcoding server 322 may have a decoding function (e.g., H.264 decoding), an encoding function (e.g., H.264 encoding) for encoding size-adjusted data, and a packetizing function for streaming. Furthermore, transcoding server 322 may perform a broadcast stream reception, a stream size adjustment, and/or a guard area adding according to control of management server 321.

Multi-channel guide providing server 323 may have a similar structure to multi-channel guide providing server 130. In other words, multi-channel guide providing server 323 may include a receiver, a multi-channel guide creation processor, and a transmitter. Herein, the receiver, the multi-channel guide creation processor, and the transmitter included in multi-channel guide providing server 323 may perform same or similar functions as receiver 21, multi-channel guide creation processor 22, and transmitter 23 included in multi-channel guide providing server 130, respectively. Multi-channel guide providing server 323 may receive a plurality of broadcast channel streams (e.g., size-adjusted broadcast channel streams) from transcoding server 322. Furthermore, multi-channel guide providing server 323 may receive multi-channel guide configuration information based on the broadcast ratings, from management server 321. Accordingly, multi-channel guide providing server 323 may create a multi-channel guide stream by combining (or stitching) the received (collected) broadcast channel streams, according to the multi-channel guide configuration information based on the broadcast ratings. Multi-channel guide providing server 323 may transmit the created multi-channel guide stream to broadcast server 100 (more specifically, IP streamer 312). In other embodiments, Multi-channel guide providing server 323 may transmit the created multi-channel guide stream to one or more user equipment.

Referring back to FIG. 3, “30a” may be a public network, “30b” to “30e” may be a private network, “30f”′ may be an intranet, and “30g” may be a coaxial cable network. However, network types are not limited thereto.

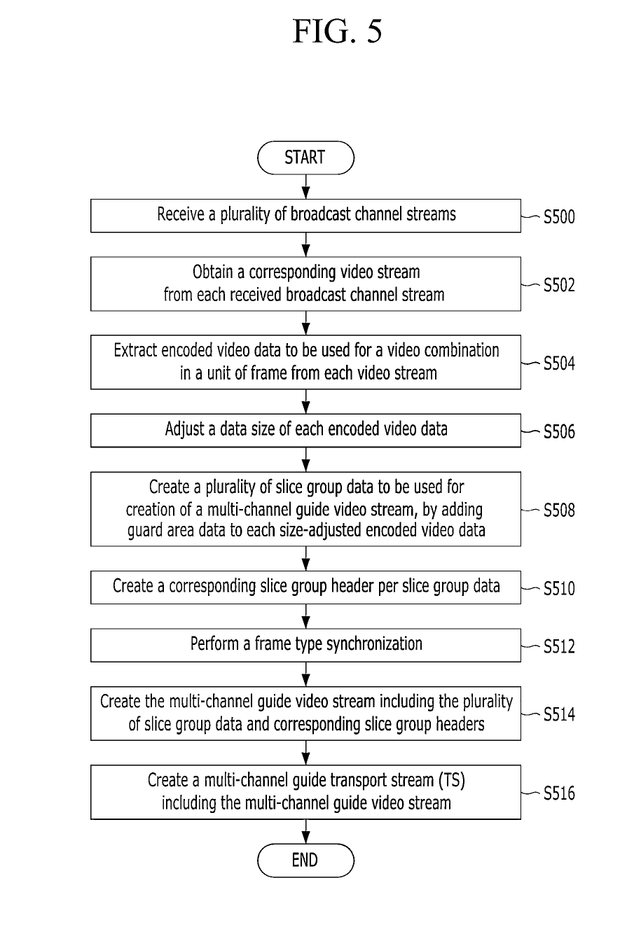

FIG. 4 illustrates a method of providing a multi-channel guide service using a video stream combination in accordance with at least one embodiment.

At step S400, statistical information providing server 120 may periodically (or in real time) transmit broadcast rating information to multi-channel guide providing server 130. Herein, the broadcast rating information may be associated with a plurality of broadcast channel streams provided by broadcast server 100.

At step S402, multi-channel guide providing server 130 may receive (or collect) a plurality of broadcast channel streams transmitted from broadcast server 100. In at least one embodiment, multi-channel guide providing server 130 may receive (or collect) only broadcast channel streams associated with the broadcast ratings, among all broadcast channel streams transmitted from broadcast server 100. Herein, the received (collected) broadcast channel streams for creating a multi-channel guide stream may be broadcast channel streams (e.g., broadcast channel streams corresponding to ranking #1 to ranking #9) in a predetermined ranking range.

At step S404, multi-channel guide providing server 130 may create a multi-channel guide stream, by combining (or stitching) the received (collected) broadcast channel streams according to multi-channel guide configuration information based on the broadcast ratings. The procedure of creating the multi-channel guide stream will be described in more detail with reference to FIG. 5 through FIG. 10B.

At step S406, when creating a multi-channel guide stream, multi-channel guide providing server 130 may transmit the multi-channel guide stream to broadcast server 100. In other embodiments, multi-channel guide providing server 130 may transmit the multi-channel guide stream to at least one user equipment 140 (e.g., UE #1, . . . , or UE #n).

At steps S408a through S408n, when receiving the multi-channel guide stream from multi-channel guide providing server 130, broadcast sever 100 may transmit the received multi-channel guide stream to user equipment 140 (e.g., UE #1, . . . , UE #n). In at least one embodiment, broadcast server 100 may multiplex at least one broadcast channel stream and the received multi-channel guide stream, and then transmit the multiplexed streams to user equipment 140. Alternatively, broadcast server 100 may separately transmit the received multi-channel guide stream to user equipment 140.

At steps S410a through S410n, when receiving the multi-channel guide stream from broadcast server 100, each user equipment (e.g., UE #1, . . . , or UE #n) may display the received multi-channel guide stream. In this case, a plurality of video streams (e.g., broadcast channel streams corresponding to ranking #1 to ranking #9) included in the multi-channel guide stream may be simultaneously displayed on a single screen of each user equipment.

At step S412, each user equipment (e.g., UE #1) may receive a user selection for a specific broadcast channel stream. For example, user equipment (e.g., UE #1) may receive a user selection for a specific broadcast channel stream (e.g., CH #1).

At step S414, when receiving the user selection for a specific broadcast channel, corresponding user equipment (e.g., UE #1) may transmit a request for a broadcast channel stream corresponding to the selected broadcast channel (e.g., CH #1). In other embodiments, in the case that broadcast server 100 includes a plurality of broadcast servers, corresponding user equipment (e.g., UE #1) may obtain access information (e.g., a broadcast channel number or a uniform resource locator (URL)) of a broadcast server corresponding to the selected broadcast channel. Herein, in the case that the multi-channel guide stream corresponds to a transport stream (TS), user equipment (e.g., UE #1) may obtain the access information from a program map table (PMT) as shown in [Table 1]. Alternatively, the user equipment (e.g., UE #1) may obtain the access information from management server 321.

At step S416, when receiving the request for the selected broadcast channel stream form the corresponding user equipment (e.g., UE #1), broadcast server 100 may provide a corresponding broadcast channel stream to the corresponding user equipment (e.g., UE #1).

At step S418, when receiving the corresponding broadcast channel stream from broadcast server 100, the corresponding user equipment (e.g., UE #1) may display the received broadcast channel stream on an entire screen of the corresponding user equipment (e.g., UE #1).

FIG. 5 illustrates a method of creating a multi-channel guide stream using a video stream combination in accordance with at least one embodiment. In other words, FIG. 5 illustrates (i) a multi-channel guide stream creation procedure performed in a multi-channel guide providing server (e.g., 130 of FIG. 2), and (ii) a multi-channel guide stream creation procedure of step S404.

Referring to FIG. 5, at step S500, multi-channel guide providing server 130 may receive a plurality of broadcast channel streams from broadcast server 100. Herein, the broadcast channel streams may be include broadcast channel transport streams which include video stream, audio stream, and/or additional data. Furthermore, the broadcast channel streams (e.g., broadcast channel transport stream) may include metadata associated with a broadcast video stream and/or a corresponding broadcast content. Herein, the metadata may include attribute information such as a screen resolution, a bit rate, a frame rate, and/or attributes of original video sources corresponding to video streams. Such metadata may be considered (or used) when a multi-channel guide stream corresponding to a single combined video stream is created.

At step S502, multi-channel guide providing server 130 may obtain a corresponding video stream from each received broadcast channel streams (e.g., broadcast channel transport streams). More specifically, multi-channel guide providing server 130 may obtain a corresponding broadcast video stream from each of the received broadcast channel streams by performing a de-multiplexing process. For example, in the case that broadcast transport stream #1 associated with CH #1 and broadcast transport stream #2 associated with CH #2 are received, multi-channel guide providing server 130 may obtain broadcast video stream #1 from broadcast transport stream #1, and obtain broadcast video stream #2 from broadcast transport stream #2.

At step S504, multi-channel guide providing server 130 may extract ‘encoded video data’ (i.e., encoded video bitstream data) to be used for a video combination (i.e., a multi-channel guide creation), in a unit of frame from each video stream. More specifically, multi-channel guide providing server 130 may extract the encoded video data from each video stream, through a data parsing process without performing an image reconstruction (e.g., decoding) procedure. For example, multi-channel guide providing server 130 may extract ‘corresponding encoded broadcast video data’ included in each broadcast video stream. Herein, a procedure of extracting the encoded video data may be performed in a unit of video frame.

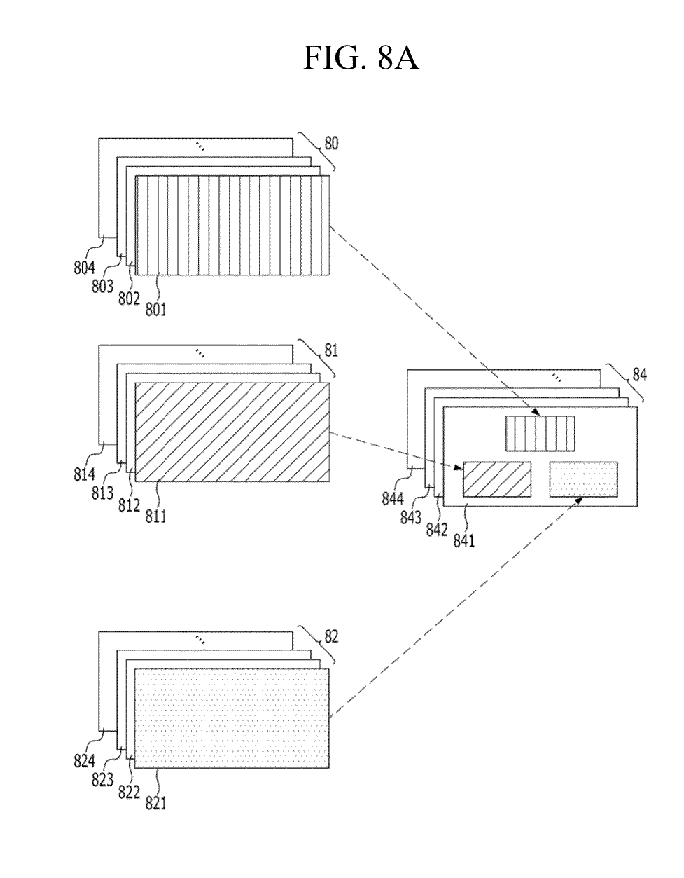

At step S506, multi-channel guide providing server 130 may adjust a data size of each encoded video data. That is, multi-channel guide providing server 130 may perform a data size adjustment for each encoded video data extracted at step S504 such that each video stream (e.g., 711, 712, 713 in FIG. 7B) is displayed at a predetermined screen area (e.g., 721, 722, 723 in FIG. 7B) on a target display screen. Herein, the data size adjustment may be performed through a transcoder. More specifically, as shown in FIG. 7A and FIG. 7B, multi-channel guide providing server 130 may reduce a data size of each encoded video data according to a mapping relation of ‘each video stream’ (e.g., 711, 712, 713) and ‘a target screen area (e.g., 721, 722, 723) on a single display screen (720).’

At step S508, multi-channel guide providing server 130 may create a plurality of slice group data to be used for creation of a multi-channel guide video stream (corresponding to a single combined video stream) by adding guard area data to each size-adjusted encoded video data. Such procedure of adding a guard area will be described in more detail with reference to FIG. 10A and FIG. 10B. In other embodiment, in the case that such procedure of adding a guard area is not performed, each size-adjusted encoded video data (“S506”) may correspond to the slice group data to be used for creation of a multi-channel guide video stream (corresponding to a single combined video stream).

At step S510, multi-channel guide providing server 130 may create a corresponding slice group header per slice group data. More specifically, multi-channel guide providing server 130 may create position information (i.e., information on a position of a corresponding slice group in a corresponding combined frame) for each slice group data such that each video stream (e.g., 711, 712, 713 in FIG. 7B) is displayed at a predetermined screen area (e.g., 721, 722, 723 in FIG. 7B) on a target display screen. Herein, the position information of each slice group data may be determined in a unit of macroblock. In other words, multi-channel guide providing server 130 may create position information for each slice group data according to a mapping relation of ‘each video stream’ (e.g., 711, 712, 713) and ‘a target screen area (e.g., 721, 722, 723) on a single display screen (720).’ Herein, the position information may be used as a slice header when creating a multi-channel guide video stream corresponding to a single combined video stream. In other embodiments, the slice group header may further include size information of each slice group.

At step S512, multi-channel guide providing server 130 may perform a frame type synchronization. More specially, multi-channel guide providing server 130 may perform the frame type synchronization such that same type frames (e.g., P frame, I frame) are combined for a creation of a multi-channel guide video stream (corresponding to a single combined video stream).

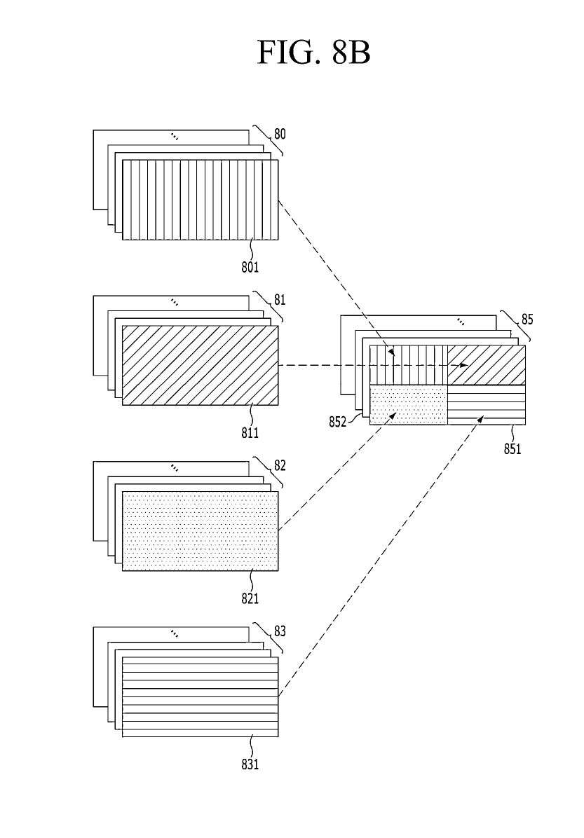

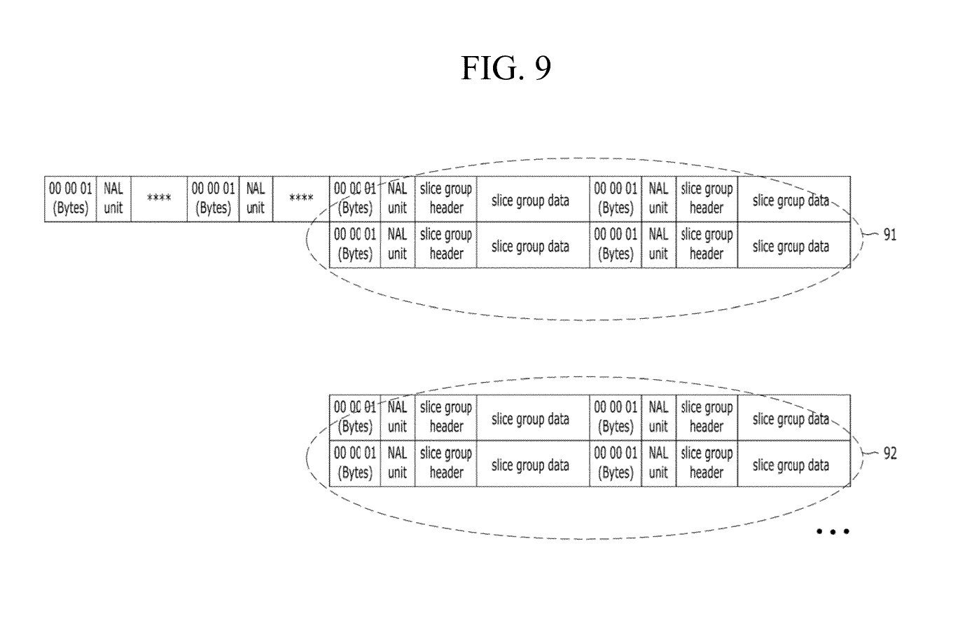

At step S514, multi-channel guide providing server 130 may create the multi-channel guide video stream (corresponding to a single combined video stream) including the plurality of slice group data and corresponding slice group header. In other words, multi-channel guide providing server 130 may create the multi-channel guide video stream using concepts of “slice group” and “slice group header” used in a flexible macroblock ordering (FMO) technique. In particular, each encoded video data extracted from each video stream (e.g., “711,” “712,” or “713” in FIG. 7B) may be considered and processed as ‘slice group data’ corresponding to the same slice group (e.g., “slice group 0,” “slice group 1,” or “slice group 2” in FIG. 7B). Such procedure of creating the multi-channel guide video stream corresponding to a single combined video stream will be described in more detail with reference to FIG. 8 A, FIG. 8B, and FIG. 9.

Furthermore, the number of video frames of a plurality of video streams to be combined may be different each other. In this case, the multi-channel guide providing server 130 may create a single combined video stream by repetitively using a specific frame (e.g., the last frame) of a video stream having less frames.

At step S516, multi-channel guide providing server 130 may create a multi-channel guide transport stream (TS) including the multi-channel guide video stream. Herein, the multi-channel guide transport stream (TS) corresponding to a single combined transport stream (TS) may include the multi-channel guide video stream (corresponding to a single combined video stream), a plurality of audio streams, and/or additional data (e.g., metadata). The plurality of audio streams may be audio data extracted from each transport stream received at step S500. For example, in the case that the multi-channel guide video stream is created using three video streams associated with CH #1, CH #2, and CH #3 as shown in FIG. 7B, three audio streams associated with CH #1, CH #2, and CH #3 may be included in the multi-channel guide transport stream (TS).

In at least one embodiment, the metadata may include multi-channel guide configuration information (e.g., configuration information associated with deployment of each broadcast stream) and/or a variety of additional information (e.g., attribute information, etc.) associated with the multi-channel guide video stream and/or corresponding audio streams. For example, the metadata may include UI templates associated with a multi-channel guide screen. The metadata may include attribute information (e.g., a screen resolution, a bit rate, a frame rate, and so forth) associated with the multi-channel guide video stream. Such metadata may be used when a multi-channel guide video stream is displayed.

Furthermore, the metadata may include access information (e.g., channel numbers, URL) of corresponding content providing servers (e.g., a broadcast server) which provide video streams included in the multi-channel guide video stream. In other embodiments, the metadata may further include access information of a third party server providing a variety of additional information associated with the multi-channel guide video stream.

In at least one embodiment, the metadata may be included in a program map table (PMT) of the multi-channel guide transport stream (TS). In this case, the metadata (e.g., channel numbers) may be included in the PMT using a private descriptor shown in [Table 2] below, or a data PID. Alternatively, the metadata may be transmitted using H. 264 supplemental enhancement information (SEI).

TABLE 2

| | No. | |
|---|---|---|
| | of | |
| Syntax | bits | Mnemonic |
| TS_program_map_section( ) { | | |
| table_id | 8 | uimsbf |
| section_syntax_indicator | 1 | bslbf |
| ‘0’ | 1 | bslbf |
| reserved | 2 | bslbf |
| section_length | 12 | uimsbf |
| program_number | 16 | uimsbf |
| reserved | 2 | bslbf |
| version_number | 5 | uimsbf |
| current_next_indicator | 1 | bslbf |
| section_number | 8 | uimsbf |
| last_section_number | 8 | uimsbf |
| reserved | 3 | bslbf |
| PCR_PID | 13 | uimsbf |
| reserved | 4 | bslbf |
| program_info_length | 12 | uimsbf |
| private_descriptor( ) | | |
| { | | |
| descriptor_tag | 8 | uimsbf |
| descriptor_length | 8 | uimsbf |
| for (i=0;i<9;i++) { | | |
| otv_ch_num | 24 | uimsbf (unsigned char |
| | | 3 bytes) |
| ots_ch_num | 24 | uimsbf (unsigned char |
| | | 3 bytes) |
| Top-Left Position_X | 16 | uimsbf |
| Top-Left Position_Y | 16 | uimsbf |
| Bottom-Right Position_X | 16 | uimsbf |
| Bottom-Right Position_Y | 16 | uimsbf |
| } | | |
| current_time | 96 | uimsbf (unsigned char |
| | | 12 bytes, |
| | | YYYYMMDDHHMM) |
| Next_time | 96 | uimsbf (unsigned char |
| | | 12 bytes, |
| | | YYYYMMDDHHMM) |
| } | | |
| for (i=0;i<N1;i++) { | | |
| stream_type | 8 | uimsbf |
| reserved | 3 | bslbf |
| elementary_PID | 13 | uimsnf |
| reserved | 4 | bslbf |
| ES_info_length | 12 | uimsbf |
| } | | |
| CRC_32 | 32 | rpchof |
| } | | |

In other embodiments, in the case that the multi-channel guide video stream corresponding to a single combined video stream is transmitted through a first session, metadata associated with the multi-channel guide video stream may be transmitted through a different session (e.g., a second session) from the first session.

In other embodiments, a content providing server (e.g., a broadcast server) may perform in advance a data size adjustment procedure and a guard area adding procedure for each video stream to be combined to create a multi-channel guide stream. In this case, multi-channel guide providing server 130 may omit the data size adjustment operation (“S506”) and/or the guard area adding operation (“S508”). Alternatively, as shown in FIG. 3, transcoding server 322 may perform in advance a data size adjustment procedure and a guard area adding procedure. In this case, multi-channel guide providing server 323 may omit the data size adjustment operation (“S506”) and/or the guard area adding operation (“S508”).

FIG. 6 illustrates an exemplary user interface for a mosaic-type multi-channel guide screen in accordance with at least one embodiment.

Referring to FIG. 6, a multi-channel guide providing server (e.g., 130) according to the present embodiment may provide a multi-channel guide stream (e.g., a mosaic-type broadcast channel guide stream) including a plurality of broadcast channel streams (e.g., broadcast channel streams corresponding to ranking #1 to ranking #9) selected based on broadcast ratings. The plurality of broadcast channel streams included in the multi-channel guide stream may be dynamically changed according to real-time broadcast ratings.

More specifically, the multi-channel guide providing server (e.g., 130) may create the multi-channel guide stream corresponding to a single combined video stream by using a plurality of ‘encoded video data’ included in a plurality of broadcast channel video streams without decoding each of the plurality of broadcast channel video streams. The multi-channel guide providing server (e.g., 130) may create the multi-channel guide stream by deploying the plurality of video streams [e.g., broadcast channel streams (e.g., 600) corresponding to ranking #1 to ranking #9]. In this case, the multi-channel guide providing server (e.g., 130) may perform a data size adjustment and/or a position information creation (e.g., a slice group header information creation) for each encoded video data such that each broadcast channel video stream (e.g., broadcast channel streams corresponding to ranking #1 to ranking #9) is displayed at a predetermined screen area (e.g., 602) on a target display screen. Such multi-channel guide creation using a video stream combination will be described in more detail with reference to FIG. 7A through FIG. 10B.

As shown in FIG. 6, when receiving a multi-channel guide stream (corresponding to a single combined broadcast video stream) including a plurality of broadcast video streams form broadcast server 100, user equipment 140 (e.g., UE #1, . . . , UE #n) may decode the received multi-channel guide stream using a single decoder, and then display the decoded multi-channel guide stream. In this case, a plurality of encoded video data (i.e., a plurality of encoded video data associated with a plurality of broadcast video streams) included in the multi-channel guide stream may be displayed on a single screen of user equipment 140. For example, as shown in FIG. 6, a plurality of broadcast streams corresponding to ranking #1 to ranking #9 may be displayed on a corresponding area (e.g., 602) of a single screen of user equipment 140.

As shown in FIG. 6, a multi-channel guide screen such as a mosaic-type multi-channel guide screen may be configured in form of a 3×3 matrix. In other embodiments, a multi-channel guide screen may be configured in form of a 2×2 or 4×4 matrix, but is not limited thereto. In the multi-channel guide screen, a broadcast channel stream (e.g., 602) with the highest rating may be placed in a top row of the screen matrix.

Furthermore, as shown in FIG. 6, additional contents may be displayed on a multi-channel guide screen. Herein, the additional contents may include long-tail contents, cloud games, interactive education contents, smart shopping contents, and so forth.

FIG. 7A and FIG. 7B illustrate a mapping relation between broadcast channel video streams and slice groups in accordance with at least one embodiment. In other words, FIG. 7A and FIG. 7B illustrate a method of mapping a plurality of broadcast channel video streams to a plurality slice groups. Hereinafter, broadcast channel video stream may be simply referred to as “video stream.”

In a typical H.264/AVC FMO technique, in order to prevent a transmission error, a picture may be partitioned into a plurality of slice groups, and each slice group may be separately encoded. A video stream combination (e.g., a video stitching) according to the present embodiment may be performed by using a concept of slice groups in a FMO technique.

Referring to FIG. 7A, a multi-channel guide stream (e.g., a mosaic-type channel guide stream) corresponding to a single combined video stream may include a plurality of slice groups. More specifically, such multi-channel guide stream corresponding to a single combined video stream may be formed by inversely applying a concept of slice group used in the FMO technique. In other words, each of a plurality of broadcast channel streams to be combined into a single video stream (i.e., multi-channel guide stream) may be mapped to each slice group. For example, as shown in FIG. 7A, a single video stream (e.g., “700”) created through a video combination procedure may be formed by four slice groups such as “slice 0” through “slice 3.” Herein, “701” through “704” represent “slice group 0,” “slice group 1,” “slice group 2,” and “slice group 3,” respectively. Slice group 3 (“704”) may be referred to as a background group. As shown in FIG. 7A, a shape of slice groups may be a square or rectangular shape according to FMO type 2 (“foreground with leftover”), but is not limited thereto. With respect to a single combined video stream (i.e., multi-channel guide stream), the number of slice groups may increase or decrease according to an addition or deletion of video streams. Furthermore, the position and/or size of slice groups may be determined or changed according to at least one of (i) the number of video streams to be combined (i.e., the number of broadcast channels to be displayed on a multi-channel guide screen), (ii) a predetermined screen configuration information, (iii) a user selection, and (iv) broadcast ratings. Furthermore, a variety of UI templates may be provided to users such that the users can select a screen structure of a multi-channel guide stream corresponding to a single combined video stream.

Referring to FIG. 7B, a multi-channel guide providing server (e.g., 130, 323) may create a multi-channel guide stream corresponding to a single combined video stream (e.g., 720), by combining a plurality of video streams (e.g., video streams 711 to 713). More specifically, the multi-channel guide providing server (e.g., 130, 323) may create the single combined video stream (e.g., 720) by deploying a plurality of video streams (e.g., video streams 711 to 713) according to a mapping relation (or correspondence relation) between “video streams to be combined into a single video stream” and “slice groups (i.e., target screen areas on a single display screen).”

For example, (i) video stream 711 of CH #1 may be mapped to slice group 0 (“721”), (ii) video stream 712 of CH #2 may be mapped to slice group 1 (“722”), and (iii) video stream 713 of CH #3 may be mapped to slice group 2 (“723”). Herein, a background image may be mapped to “slice group 3 (background group)” (“724”). The background image may be determined by at least one of multi-channel guide providing server (e.g., 130, 323), management server 321, and a user selection. In other embodiments, as shown in FIG. 8B, the multi-channel guide providing server (e.g., 130, 323) may be formed without the background group (e.g., slice group 3 (“724”)).

Meanwhile, with respect to a multi-channel guide screen (e.g., a mosaic-type channel guide screen), a template (e.g., a UI template) associated with a multi-channel guide screen configuration may be considered and processed as a background part other than display areas (e.g., “602” in FIG. 6) of corresponding broadcast channel streams. As described above, the template (e.g., a UI template) and/or related information (e.g., template attribute information) may be provided as metadata to at least one user equipment. In this case, at least one user equipment may configure (or display) the background part of a multi-channel guide screen using the template (e.g., a UI template) and the related information, and display a plurality of corresponding broadcast channel streams on each pre-determined screen area (e.g., “602” in FIG. 6) by performing decoding procedure using each slice group data and a corresponding slice group header.

A multi-channel guide providing server (e.g., 130, 323) may provide a variety of UI templates associated with a multi-channel guide screen, to user equipment. The UI templates may be provided as metadata to the user equipment. In this case, at least one user equipment may provide the variety of UI templates to a corresponding user, and receive a user selection from the user. The user equipment may configure a multi-channel guide screen using a multi-channel guide video stream and the selected UI template.

Meanwhile, in other embodiments, the background part (e.g., a background image) of a multi-channel guide screen may be considered and processed as a slice group (e.g., slice group 3). In this case, in user equipment, the slice group data corresponding to the background part may be decoded/displayed in a same or similar manner as the other slice group data (i.e., slice group data corresponding to broadcast channel streams).

FIG. 8A and FIG. 8B illustrate a concept of a video stream combination which is performed in a unit of frame in accordance with at least one embodiment.

FIG. 8A illustrates a video combination procedure of forming a single combined video stream by combining three video streams (e.g., three broadcast channel streams). In particular, FIG. 8A illustrates embodiments including a slice group corresponding to a background group.

As shown in FIG. 8A, each video stream (e.g., 80, 81, and 82) may include a plurality of image frames. For example, video stream 80 (e.g., video streams of CH #1) may include a plurality of image frames such as frame #0 (801), frame #1 (802), frame #2 (803), and frame #3 (804). Video stream 81 (e.g., video streams of CH #2) may include a plurality of image frames such as frame #0 (811), frame #1 (812), frame #2 (813), and frame #3 (814). Video stream 82 (e.g., video streams of CH #3) may include a plurality of image frames such as frame #0 (821), frame #1 (822), frame #2 (823), and frame #3 (824).

In this case, a single combined video stream may be formed using “corresponding encoded video data” included in the three video streams (80, 81, 82) in a unit of frame. More specifically, combined frame #0 (841) of the single combined video stream 84 may be formed using (i) encoded video data corresponding to frame #0 (801) of video stream 80, (ii) encoded video data corresponding to frame #0 (811) of video stream 81, (iii) encoded video data corresponding to frame #0 (821) of video stream 82, and (iv) encoded video data corresponding to a background image. In this case, each of the plurality of encoded video data may be size-adjusted, and then be processed as slice group data. In the same manner, combined frame #1 (842), combined frame #2 (843), and combined frame #3 (844) may be formed.

Meanwhile, FIG. 8B illustrates a video combination procedure of forming a single combined video stream by combining four video streams (e.g., four broadcast channel streams). In particular, FIG. 8B illustrates embodiments not including a slice group corresponding to a background group. As described in FIG. 8B, a single combined video stream 85 may be formed by combining four video streams (80, 81, 82, and 83) in a unit of frame. More specifically, combined frame #0 (851) of the single combined video stream 85 may be formed using (i) encoded video data corresponding to frame #0 (801) of video stream 80, (ii) encoded video data corresponding to frame #0 (811) of video stream 81, (iii) encoded video data corresponding to frame #0 (821) of video stream 82, and (iv) encoded video data corresponding to frame #0 (831) of video stream 83. In this case, combined frames of the single combined video stream 85 may be formed without a background image.

More specifically, a multi-channel guide providing server according to at least one embodiment may extract required portions (i.e., encoded video data) from the bitstreams of a plurality of video streams (e.g., broadcast channel streams received from broadcast server 100), and create a single combined video stream using the extracted bitstream portions (i.e., encoded video data). Such video stream combination scheme using a plurality of encoded video data extracted from a plurality of video streams will be described in more detail with reference to FIG. 9.

FIG. 9 illustrates a bitstream structure of a multi-channel guide stream corresponding to a single combined video stream in accordance with at least one embodiment.

As described in FIG. 8A and FIG. 8B, a multi-channel guide stream corresponding to a single combined video stream (i.e., a single video stream created by combining a plurality of video streams) may be a set of combined frames (e.g., 84, 85). Herein, the combined frames (e.g., 84, 85) may be created using a plurality of encoded video data extracted from the plurality of video streams (e.g., 80, 81, 82, 83) in a unit of frame. In this case, each of the plurality of encoded video data may be size-adjusted, and then be processed as slice group data.

FIG. 9 illustrates a bitstream structure (e.g., H.264 bitstream structure) to which FMO type 2 is applied, in the case that each combined frame of a single video stream is formed by four slice groups. For example, as shown in FIG. 8A, four slice groups may include (i) three slice groups for three video streams, and (ii) one slice group corresponding to a background group. Alternatively, as shown in FIG. 8B, four slice groups may include four slice groups for four video streams without a background group.

For example, “91” represents a bitstream structure associated with “combined frame 841” or “combined frame 851.” Herein, each “slice group data” field may include “encoded video data” (more specifically, size-adjusted encoded video data) corresponding to each video stream (e.g., CH #1, CH #2, CH #3, or CH #4). “92” represents a bitstream of “combined frame 842” or “combined frame 852.” Each “slice group header” field may include position information (i.e., information on a position of the slice group in a corresponding combined frame) on a corresponding slice group.

In other embodiments, the background group (e.g., 724 in FIG. 7B) may be configured with a UI template. In this case, the UI template may be provided as metadata to user equipment.

FIG. 10A and FIG. 10B illustrate a method of adding a guard area in order to overcome a decoding error at a boundary portion of slice groups in accordance with at least one embodiment.

As shown in FIG. 10A, in the case that a video combination (e.g., image stitching) is performed using an FMO technique, a video decoding may not be properly performed at a boundary of image frames to be combined, due to influence of neighboring slice data. Furthermore, in this case, such decoding error (i.e., a distortion in decoded images) may be propagated to a neighboring portion from the boundary. More specifically, in an H.264 standard, in case of a boundary of each image frame, there may be no macroblock data to be used as reference blocks. Accordingly, in this case, a typical encoding scheme may perform an encoding procedure after padding reference blocks having a specific value (e.g., 0 or 128). However, in the case that a video combination (e.g., video stitching) is performed as shown in FIG. 10A, boundary portions of each slice group (i.e., each slice group corresponding to a video frame to be combined) may be filled with macroblocks of other neighboring slice groups, and then a decoding procedure may be performed. In other words, in case of a single combined video stream, a decoding procedure at a boundary portion (e.g., 1000) of slice groups may be performed using macroblock data of other neighboring slice groups other than the above-described padding macroblock data (e.g., 0 or 128), thereby resulting in a decoding error.

Meanwhile, as shown in FIG. 10B, in order to prevent such decoding error (i.e., a distortion in decoded images), the present embodiment may introduce (or set) a guard area (e.g., 1002) at a boundary of each image frame to be combined (e.g., stitched). Herein, the guard area may be formed through a zero padding. Furthermore, as shown in FIG. 10B, macroblocks surrounding each image frame to be combined (e.g., stitched) may be determined as the guard area. Accordingly, in the case that a single combined video stream is decoded, neighboring slice groups including the guard area may have the same block value (e.g., zero) at a boundary portion, and thereby preventing an image distortion due to neighboring other slice groups.

The present embodiment may provide a video-based channel guide service. The present embodiment may create a multi-channel guide stream (e.g., a mosaic-type channel guide stream) by combining a plurality of encoded broadcast video streams in a mosaic type arrangement, without performing decoding each of the encoded broadcast video stream. More specifically, the present embodiment may not provide a video combination scheme that (i) reconstructs corresponding images by decoding each of a plurality of broadcast channel streams, (ii) physically creates a channel guide screen image using the reconstructed images, and (iii) then encodes the channel guide screen image. In other words, as described above, the present embodiment may logically form a channel guide stream (i.e., a multi-channel guide stream) such that a plurality of broadcast channel streams are displayed on a single screen of user equipment. Accordingly, when receiving a mosaic-type channel guide stream (corresponding to a single combined video stream), user equipment may decode the mosaic-type channel guide stream using a single decoder, and thereby displaying a plurality broadcast video streams on a single screen without having a plurality of decoders corresponding to the number of broadcast video streams. In other words, even in case of a low-performance user equipment having a single decoder, a plurality of broadcast video streams may be displayed at the same time on a single screen.

Furthermore, the present embodiment may provide a dynamic channel guide service based on broadcast ratings (particularly, real-time broadcast ratings). More specifically, a mosaic-type channel guide according to the present embodiment may be dynamically changed according to broadcast ratings (e.g., real-time broadcast ratings). In addition, the dynamic channel guide service may be provided based on Internet protocol (IP).

The present embodiment may provide premium channels through a mosaic-type channel guide screen, thereby inducing a sales promotion of related goods.

Even in the case that a mosaic-type channel guide stream is transmitted through a multicast transmission scheme, the present embodiment may transmit metadata associated with a user interface (UI) through which users can select a desired channel.

The present embodiment may provide a mosaic-type channel guide screen having a plurality of screen pages, thereby enabling users to have experience of a screen page change.

Meanwhile, in at least one embodiment, methods of performing a video combination (e.g., an image stitching), and/or methods of providing a dynamic multi-channel guide service using the video stream combination scheme may be embodied in the form of a computer-readable recording medium (e.g., a non-transitory computer-readable recording medium) storing a computer executable program that, when executed, causes a computer to perform the method(s).

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of providing a multi-channel guide service, the method comprising:
obtaining broadcast ratings;
obtaining a plurality of broadcast channel streams associated with the broadcast ratings;
creating a multi-channel guide stream using encoded video data included in each of the plurality of broadcast channel streams, according to multi-channel guide configuration information, wherein the multi-channel guide configuration information is determined based on the broadcast ratings; and
providing the multi-channel guide stream to at least one of a broadcast server and user equipment.

2. The method of claim 1, wherein the obtaining broadcast ratings includes:
receiving periodically the broadcast ratings from a statistical information providing server.

3. The method of claim 1, wherein the plurality of broadcast channel streams are broadcast channel streams in a predetermined ranking range.

4. The method of claim 1, wherein the creating a multi-channel guide stream includes:
extracting encoded video data in a unit of video frame, from each of the plurality of broadcast channel streams;
creating a plurality of slice group data to be used for creation of the multi-channel guide stream, from a plurality of encoded video data;
creating slice group header information per slice group data; and
forming the multi-channel guide stream including the plurality of slice group data and a plurality of slice group header information.

5. The method of claim 4, wherein the creating a plurality of slice group data includes at least one of:
adjusting a data size of each encoded video data; and
adding guard area data to each encoded video data.

6. The method of claim 5, wherein the adjusting includes:
performing a data size adjustment such that each encoded video data is displayed at a predetermined screen area on a target display screen.

7. The method of claim 6, wherein:
the data size adjustment is performed according to a mapping relation of each broadcast channel stream and a slice group corresponding to the target screen area; and
the mapping relation is determined based on the broadcast ratings.

8. The method of claim 5, wherein the adding guard area data includes:
adding the guard area data to each size-adjusted encoded video data such that a decoding error due to neighboring slice groups is prevented.

9. The method of claim 1, wherein:
the slice group header information includes position information associated with each slice group corresponding to each slice group data; and
the position information is determined based on the broadcast ratings.

10. The method of claim 4, wherein the position information is determined such that each encoded video data is displayed at a predetermined screen area on a target display screen.

11. The method of claim 1, further comprising:
creating a broadcast channel guide transport stream (TS) by multiplexing at least one of the multi-channel guide stream, corresponding audio streams, and additional information.

12. The method of claim 11, wherein the additional information includes at least one of (i) metadata associated with configuration of the multi-channel guide stream, and (ii) access information of the broadcast server.

13. The method of claim 4, further comprising:
performing a frame type synchronization for the plurality of slice group data.

14. The method of claim 4, wherein the slice group data and the slice header information are based on a flexible macroblock ordering (FMO) technique.

15. The method of claim 1, wherein the multi-channel guide configuration information is associated with a preset user interface (UI) template.

16. A system for providing a multi-channel guide service, the system comprising:
a first receiver configured to obtain broadcast ratings;
a second receiver configured to receive a plurality of broadcast channel streams associated with the broadcast ratings;
a multi-channel guide creation processor configured to create a multi-channel guide stream using encoded video data included in each of the plurality of broadcast channel streams, according to multi-channel guide configuration information, wherein the multi-channel guide configuration information is determined based on the broadcast ratings; and
a transmitter configured to transmit the multi-channel guide stream to at least one of a broadcast server and user equipment.

17. The system of claim 16, wherein the plurality of broadcast channel streams are broadcast channel streams in a predetermined ranking range.

18. The system of claim 16, wherein the multi-channel guide creation processor is configured to:
extract encoded video data in a unit of video frame, from each of the plurality of broadcast channel streams;
create a plurality of slice group data to be used for creation of the multi-channel guide stream, from a plurality of encoded video data;
create slice group header information per slice group data; and
form the multi-channel guide stream including the plurality of slice group data and a plurality of slice group header information.

19. The system of claim 18, wherein the multi-channel guide creation processor is configured to create the plurality of slice group data by performing at least one of:
(i) a data size adjustment procedure for each encoded video data such that each encoded video data is displayed at a predetermined screen area on a target display screen; and
(ii) a guard area adding procedure for preventing a decoding error due to neighboring slice groups.

20. The system of claim 18, wherein:
the slice group header information includes position information associated with each slice group corresponding to each slice group data; and
the position information is determined based on the broadcast ratings.
